(19) United States
(12) Patent Application Publication
(10) Pub. No.: US 2013/0208230 A1
(43) Pub. Date: Aug. 15, 2013

(54) APPARATUS FOR ANCHORING EYEGLASS HOLDER BANDS

(71) Applicant: Avraham YACOBI, Ohr Akiva (IL)

(72) Inventor: Avraham YACOBI, Ohr Akiva (IL)

(21) Appl. No.: 13/400,151

(22) Filed: Feb. 20, 2012

Related U.S. Application Data
(63) Continuation-in-part of application No. 13/369,416, filed on Feb. 9, 2012, now abandoned.

(51) Int. Cl. G02C 5/14

(52) U.S. Cl. 351/111

(57) ABSTRACT

A loop anchor for an eyeglasses holder band includes a leading edge of convex shape to facilitate slipping a loop attached to the holder band over both the loop anchor and a section of an eyeglasses temple on which the loop anchor is mounted, and a trailing edge of concave shape to prevent the loop from slipping off of the loop anchor. Alternatively, a loop anchor for an eyeglasses holder band includes a rounded head, where a top portion of said rounded head is rounded and a bottom portion is flattened, and a pin connected to both said rounded head and an eyeglasses temple, where the bottom portion of the rounded head is configured to prevent a loop attached to the eyeglass holder from slipping off the pin, thereby anchoring the eyeglasses band holder to the eyeglasses temple.

### CROSS-REFERENCE TO RELATED APPLICATIONS

This application is a continuation-in-part application of U.S. patent application Ser. No. 13/369,416 filed Feb. 9, 2012, which is hereby incorporated in its entirety by reference.

### FIELD OF THE INVENTION

The present invention relates to eyeglasses generally and to anchoring eyeglass holder bands in particular.

### BACKGROUND OF THE INVENTION

Eyeglass holder bands, or “glass bands”, are known in the art. They typically comprise a flexible band that is attachable to the temples or earpieces of a pair of eyeglasses. They normally have loops at each end that are used to attach the glass band to a pair of glasses by slipping them over the bottom portions of the earpieces.

Children and athletes often use glass bands to prevent their eyeglasses from falling off. Wearers of reading glasses and sunglasses often use somewhat longer glass bands to hold their glasses when not in use, effectively forming a necklace with the attached glasses resting on their chests.

The efficacy of a glass holder band is a function of a multiplicity of factors, including, for example, movements by the wearer, the size of the loops, the shape of the earpiece over which the loops are slipped, and the presence and quality of a cinch mechanism for the loops. Unsurprisingly, glass bands don't always work properly. Sometimes one of the loops slips off of the earpieces.

### SUMMARY OF THE PRESENT INVENTION

There is provided in accordance with a preferred embodiment of the present invention, a loop anchor for an eyeglasses holder band including a leading edge of convex shape to facilitate slipping a loop attached to the holder band over both the loop anchor and a section of an eyeglasses temple on which the loop anchor is mounted; and a trailing edge of concave shape to prevent the loop from slipping off of the loop anchor.

Further, in accordance with a preferred embodiment of the present invention, the loop anchor is positioned on the eyeglasses temple such that an eyeglasses earpiece extending from the eyeglasses temple must be threaded through the loop in order to slip the loop over both the loop anchor and the section of the eyeglasses temple.

Still further, in accordance with a preferred embodiment of the present invention, the loop anchor is mounted to extend vertically from the section of an eyeglasses temple.

There is also provided, in accordance with a preferred embodiment of the present invention, a loop anchor for an eyeglasses holder band including a flattened head and a pin connected to both the flattened head and an eyeglasses temple, where the flattened head is configured to prevent a loop attached to the eyeglass holder from slipping off the pin, thereby anchoring the eyeglasses band holder to the eyeglasses temple.

Further, in accordance with a preferred embodiment of the present invention, the pin extends vertically from the eyeglasses temple.

Still further, in accordance with a preferred embodiment of the present invention, the pin is threaded to facilitate attaching it to the eyeglasses temple by screwing it into a hole in the eyeglasses temple.

Additionally, in accordance with a preferred embodiment of the present invention, a distance between the flattened head and the eyeglasses temple is configurable according to a depth to which the pin is screwed into the hole.

Moreover, in accordance with a preferred embodiment of the present invention, the loop anchor is configurable to clasp the loop by adjustment of the depth.

Further, in accordance with a preferred embodiment of the present invention, the loop anchor is removable.

Still further, in accordance with a preferred embodiment of the present invention, the loop anchor is replaceable.

Additionally, in accordance with a preferred embodiment of the present invention, the eyeglasses temple is configurable to have multiple said loop anchors attached to it.

There is also provided, in accordance with a preferred embodiment of the present invention, a loop anchor for an eyeglasses holder band including a rounded head, where a top portion of the rounded head is rounded and a bottom portion is flattened, and a pin connected to both the rounded head and an eyeglasses temple, where the top portion of the rounded head is configured to facilitate slipping a loop over it, and the bottom portion of the rounded head is configured to prevent a loop attached to said eyeglass holder from slipping off the pin, thereby anchoring said eyeglasses band holder to said eyeglasses temple.

Further, in accordance with a preferred embodiment of the present invention, the pin extends vertically from the eyeglasses temple.

Still further, in accordance with a preferred embodiment of the present invention, the pin is threaded to facilitate attaching it to the eyeglasses temple by screwing it into a hole in the eyeglasses temple.

Additionally, in accordance with a preferred embodiment of the present invention, a distance between the rounded head and the eyeglasses temple is configurable according to a depth to which the pin is screwed into the hole.

Moreover, in accordance with a preferred embodiment of the present invention, the loop anchor is configurable to clasp the loop by adjustment of the depth.

Further, in accordance with a preferred embodiment of the present invention, the loop anchor is removable.

Still further, in accordance with a preferred embodiment of the present invention, the loop anchor is replaceable.

Additionally, in accordance with a preferred embodiment of the present invention, the eyeglasses temple is configurable to have multiple said loop anchors attached to it.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an illustration of a set of eyeglasses with a novel glass holder band anchor, constructed and operative in accordance with a preferred embodiment of the present invention;

FIG. 1B is a close up view of the anchor of FIG. 1A;

FIGS. 2A-2C are illustrations of an alternative version of the anchor of FIG. 1A, constructed and operative in accordance with an alternative preferred embodiment of the present invention; and

FIGS. 3A and 3B are illustrations of an another alternative version of the anchor of FIG. 1A, constructed and operative in accordance with an alternative preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

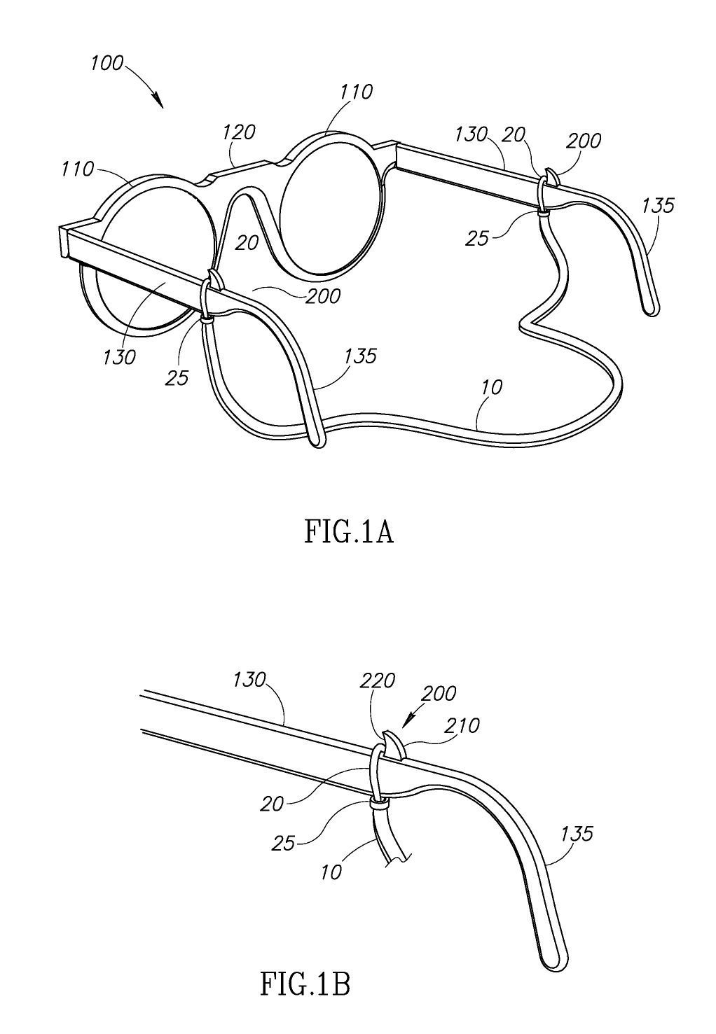

Applicant has realized that the efficacy of glass holder bands may be improved by providing an “anchor” for them on the eyeglasses themselves. Reference is now made to FIG. 1A which illustrates a novel pair of eyeglasses 100 comprising loop anchors 200 to prevent slippage. Eyeglasses 100 may also comprise lens frames 110, bridge 120, temples 130 and earpieces 135. As depicted in FIG. 1A, glass holder band 10 may be attachable to eyeglasses 100 by threading earpieces 135 through loops 20 and slipping loops 20 over loop anchors 200. Cinches 25 may be used to tighten loops 20. It will be appreciated that loops 20 may typically be flexible in nature such that they may be stretched by the eyeglasses wearer to fit over loop anchors 200. Once released by the wearer and tightened by cinches 25 they may not easily slip back over loop anchor 200.

Reference is now made to FIG. 1B which may illustrate a close up view of the right temple 130 and earpiece 135 of the eyeglasses 100 from FIG. 1A. Loop anchor 200 may be a fin shaped protrusion extending vertically from temple 130. Loop anchor 200 may comprise leading edge 210 and trailing edge 220. Leading edges 210 may be generally convex in shape to facilitate a wearer of eyeglasses 100 easily slipping loops 20 over leading edges 210. Conversely, trailing edges 220 may have a generally concave shape which may serve to prevent loops 20 from slipping off of loop anchor 200.

It will be appreciated that the depiction of eyeglasses 100 may be exemplary; the current invention may be configured for any type of eyeglasses, including, for example, prescription eyeglasses, reading glasses, and sunglasses. The present invention may similarly provide support for generally all design details for eyeglasses of present invention, including, for example, the shapes and widths of temples 130 and earpieces 135, the style of lens frames 110 and bridge 120, and the materials from which eyeglasses 100 may be constructed. It will also be appreciated that the placement of loop anchor 200 on temple 130 as depicted in FIGS. 1 may also be exemplary; the present invention may provide support for placing loop anchor in a vertical or even horizontal position from any section of temple 130. Similarly, loop anchor 200 may also be positioned to extend from earpiece 135.

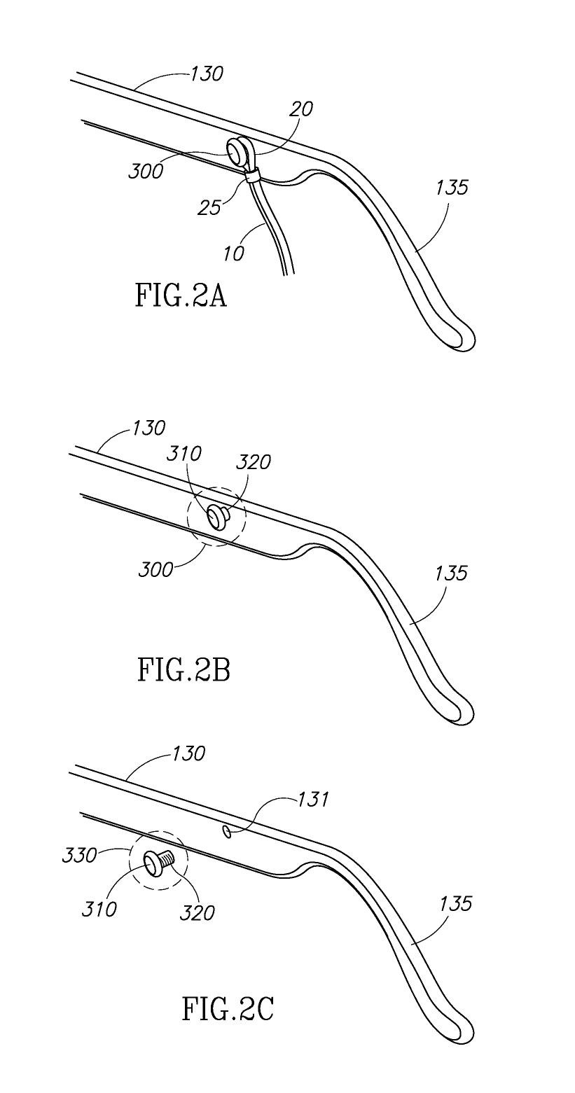

Reference is now made to FIG. 2A and 2B which together illustrate an alternative preferred embodiment of the present invention with a novel loop anchor 300 extending horizontally from the side of temple 130. FIG. 2A may depict the temple 130 and earpiece 135 of eyeglasses 100 (FIG. 1A). Loop anchor 300 may extend horizontally from temple 130. As shown in FIG. 2B, loop anchor 300 may comprise flattened head 310 and pin 320. As shown in FIG. 2A, loop 20 may be slipped over flattened head 310 to attach band 10 to glasses 100. However, it will be appreciated that flattened head 310 may prevent loop 20 from slipping off of loop anchor 300.

Applicant has realized that it may be convenient for an eyeglass wearer if loop anchors 300 may be removable. FIG. 2C, to which reference is now made, illustrates a novel removable loop anchor 300, constructed and operative in accordance with a preferred embodiment of the present invention. As depicted in FIG. 2C, pin 320 may be threaded to facilitate screwing loop anchor into hole 131 on temple 130. It will therefore be appreciated that loop anchor 300 may be removable; an eyeglass wearer may remove loop anchor 300 if so desired.

It will further be appreciated that in such manner a wearer may “accessorize” interchangeable loop anchors 300. For example, more than one set of loop anchors 300 may be provided with, or available for, a given pair of eyeglasses 100. The sets of loop anchors 300 may be differentiated according to color or style. Accordingly, the wearer may select which, if any, of the interchangeable loop anchors to attach to a given pair of eyeglasses 100 according to personal preference.

Furthermore, in accordance with another preferred embodiment of the present invention, the depth to which pin 320 may be screwed into hole 131 may be variable, thus enabling the wearer to generally tighten flattened head 310 against loop 20 to hold it in place against temple 131.

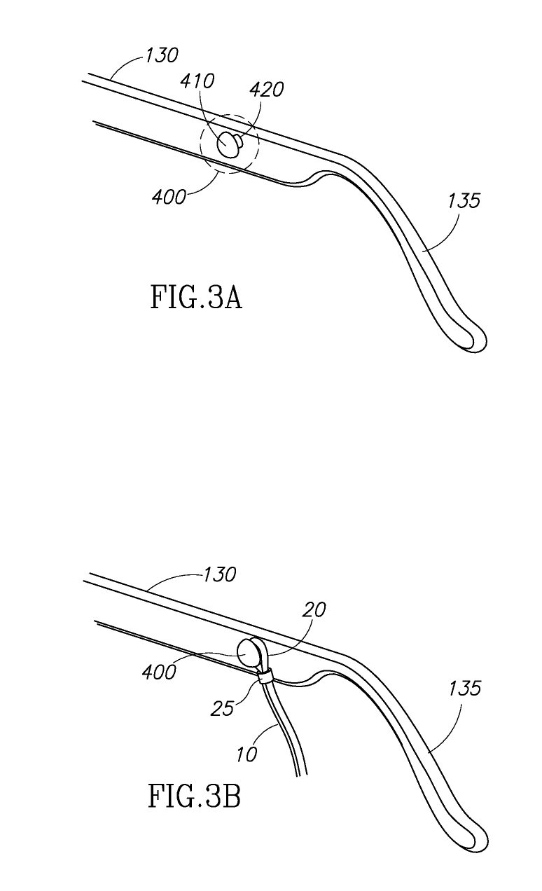

Applicant has further realized that it may be difficult to slip loop 20 over flattened head 310; not all loops 20 may be sufficiently flexible, and in any case stretching loop 20 over flat surface may be difficult for some eyeglasses wearers, particularly for children and the elderly. FIGS. 3A and 3B, to which reference is now made, together illustrate an alternative preferred embodiment of the present invention with a novel rounded head loop anchor 400, constructed and operative in accordance with a preferred embodiment of the present invention.

As illustrated in FIG. 3A, loop anchor 400 may be configured and positioned on temple 130 in a generally similar manner as loop anchor 300. However, instead of flattened head 310, loop anchor 400 may comprise rounded head 410 to facilitate the relatively easy sliding of loop 20 over rounded head 410 in order for it to hold pin 420. The lower portion of rounded head 410 may be flattened to generally prevent loop 20 from slipping back over rounded head 410. FIG. 3A depicts loop 200 held to temple 130 by loop anchor 400.

It will be appreciated that the depiction of eyeglasses 100 in FIGS. 1 and 2 may be exemplary; the current invention may be configured for any type of eyeglasses, including, for example, prescription eyeglasses, reading glasses, and sunglasses. The present invention may similarly provide support for generally all design details for eyeglasses, including, for example, the shapes and widths of temples 130 and earpieces 135, the style of lens frames 110 and bridge 120, and the materials from which eyeglasses 100 may be constructed. It will also be appreciated that the placement of loop anchors 200 and 300 on temple 130 as depicted in FIGS. 1, 2 and 3 may also be exemplary; the present invention may provide support for placing loop anchors 200 and 300 in generally any position on any section of temple 130, earpiece 135, or lens frames 110. Furthermore, multiple loop anchors 200, 300 and/or 400 may be positioned on a single temple 130 or set of eyeglasses 10.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A loop anchor for an eyeglasses holder band comprising:
a leading edge of convex shape to facilitate slipping a loop attached to said holder band over both said loop anchor and a section of an eyeglasses temple on which said loop anchor is mounted; and
a trailing edge of concave shape to prevent said loop from slipping off of said loop anchor.

2. The loop anchor according to claim 1 and wherein said loop anchor is positioned on said eyeglasses temple such that an eyeglasses earpiece extending from said eyeglasses temple must be threaded through said loop in order to slip said loop over both said loop anchor and said section of said eyeglasses temple.

3. The loop anchor according to claim 1 and wherein said loop anchor is mounted to extend vertically from said section of an eyeglasses temple.

4. A loop anchor for an eyeglasses holder band comprising:
a flattened head; and
a pin connected to both said flattened head and an eyeglasses temple, wherein said flattened head is configured to prevent a loop attached to said eyeglass holder from slipping off said pin, thereby anchoring said eyeglasses band holder to said eyeglasses temple.

5. The loop anchor according to claim 4 and wherein said pin extends vertically from said eyeglasses temple.

6. The loop anchor according to claim 4 and wherein said pin is threaded to facilitate attaching it to said eyeglasses temple by screwing it into a hole in said eyeglasses temple.

7. The loop anchor according to claim 5 and wherein a distance between said flattened head and said eyeglasses temple is configurable according to a depth to which said pin is screwed into said hole.

8. The loop anchor according to claim 7 and wherein said loop anchor is configurable to clasp said loop by adjustment of said depth.

9. The loop anchor according to claim 5 and wherein said loop anchor is removable.

10. The loop anchor according to claim 5 and where said loop anchor is replaceable.

11. The loop anchor according to claim 4 and wherein said eyeglasses temple is configurable to have multiple said loop anchors attached to it.

12. A loop anchor for an eyeglasses holder band comprising:
a rounded head, wherein a top portion of said rounded head is rounded and a bottom portion is flattened; and
a pin connected to both said rounded head and an eyeglasses temple, wherein said top portion of said rounded head is configured to facilitate slipping a loop over it, and said bottom portion of said rounded head is configured to prevent a loop attached to said eyeglass holder from slipping off said pin, thereby anchoring said eyeglasses band holder to said eyeglasses temple.

13. The loop anchor according to claim 12 and wherein said pin extends vertically from said eyeglasses temple.

14. The loop anchor according to claim 12 and wherein said pin is threaded to facilitate attaching it to said eyeglasses temple by screwing it into a hole in said eyeglasses temple.

15. The loop anchor according to claim 13 and wherein a distance between said rounded head and said eyeglasses temple is configurable according to a depth to which said pin is screwed into said hole.

16. The loop anchor according to claim 15 and wherein said loop anchor is configurable to clasp said loop by adjustment of said depth.

17. The loop anchor according to claim 13 and wherein said loop anchor is removable.

18. The loop anchor according to claim 13 and where said loop anchor is replaceable.

19. The loop anchor according to claim 12 and wherein said eyeglasses temple is configurable to have multiple said loop anchors attached to it.
